(19) United States
(12) Patent Application Publication
(10) Pub. No.: US 2025/0217637 A1
(43) Pub. Date: Jul. 3, 2025

(54) NANO ELECTROMECHANICAL NEURON DEVICE BASED ON SPIKING NEURAL NETWORK

(71) Applicant: SEOUL NATIONAL UNIVERSITY R&DB FOUNDATION, Seoul (KR)

(72) Inventors: Woo Young CHOI, Seoul (KR); Jae Seung WOO, Seoul (KR); Geuntae PARK, Seoul (KR)

(73) Assignee: SEOUL NATIONAL UNIVERSITY R&DB FOUNDATION, Seoul (KR)

(21) Appl. No.: 18/824,524

(22) Filed: Sep. 4, 2024

(30) Foreign Application Priority Data
Dec. 29, 2023 (KR) 10-2023-0196970
Jul. 8, 2024 (KR) 10-2024-0089754

(51) Int. Cl. G06N 3/065; G06N 3/049

(52) U.S. Cl. CPC G06N 3/065; G06N 3/049

(57) ABSTRACT

A nano electromechanical neuron device based on a spiking neural network, includes: a first gate electrode receiving a first voltage; a second gate electrode disposed in parallel and spaced apart from the first gate electrode and receiving a second voltage; a drain electrode disposed at a predetermined distance from one end of the first gate electrode and receiving a spike current signal; a movable beam disposed between the first and second gate electrodes and bending in a direction toward the drain electrode according to a spike current signal; and an anchor for securing the movable beam to a lower layer.

### CROSS-REFERENCE TO PRIOR APPLICATIONS

This application claims priority to Korean Patent Application Nos. 10-2023-0196970 (filed on Dec. 29, 2023) and 10-2024-0089754 (filed on Jul. 8, 2024), which are all hereby incorporated by reference in their entirety.

### ACKNOWLEDGEMENT

National research and development project supporting the present invention
[Project Serial No] 1711158813
[Tax Project No] 2021M3F3A2A01037927
[Name of department] Ministry of Science and ICT, Republic of Korea
[Task management (professional) institution name] National Research Foundation of Korea
[Research Project name] Development of new resource technology
[Research Task Name] Neuronal circuits based on synaptic elements and new elements for improving SNN performance
[Name of task performing organization] Seoul National University
[Research period] Apr. 9, 2021 to Dec. 31, 2023

National research and development project supporting the present invention
[Project Serial No] 1711182048
[Tax Project No] 2022M3F3A2A01073944
[Name of department] Ministry of Science and ICT, Republic of Korea
[Task management (professional) institution name] National Research Foundation of Korea
[Research Project name] Development of next-generation intelligent semiconductor technology (devices)
[Research Task Name] Development of NEM associative memory-augmented neural network based on CMOS wiring technology
[Name of task performing organization] Seoul National University
[Research period] Jan. 1, 2023 to Dec. 31, 2023

National research and development project supporting the present invention
[Project Serial No] 1711187103
[Tax Project No] 2021R1A2C1007931
[Name of department] Ministry of Science and ICT, Republic of Korea
[Task management (professional) institution name] National Research Foundation of Korea
[Research Project name] Individual Basic Research (Ministry of Science and ICT)
[Research Task Name] Development of brain-mimicking computing technology for monolithic three-dimensional integration of ultra-low power non-volatile memory devices
[Name of task performing organization] Seoul National University
[Research period] Mar. 1, 2023 to Feb. 29, 2024

### BACKGROUND

The present disclosure relates to a spiking neural network hardware implementation technique, and more particularly to a spiking neural network-based nano electromechanical neuron device utilizing a nano electromechanical (NEM) relay switch.

Recent advancements in artificial intelligence technologies, such as autonomous driving, image processing, and ChatGPT, have become a hot topic of discussion. However, while the human brain consumes only about 20 W of energy during cognitive processes, high-performance AI requires extensive data computations, which inevitably leads to significant power consumption when processed by hardware. Consequently, neuromorphic computing based on Spiking Neural Networks (SNNs) has garnered much attention as it aims to emulate the ultra-low power operation of the human brain.

The human brain consists of a vast number of neurons interconnected by synapses. A neuron accumulates charge in the membrane thereof in response to incoming stimuli, and when a voltage resulting from the membrane charge exceeds a predetermined threshold, the neuron generates a spike and transmits an electrical signal to the next neuron through a synapse. SNNs operate in a manner very similar to the human brain, and active research is underway to efficiently implement a neuron circuit that accumulates membrane charges and generates spikes.

However, until recently, hardware-based SNNs have relied on a CMOS technology composed solely of transistors to implement neuron operations. A CMOS-based neuron circuit requires approximately 10 transistors which result in the occupation of large areas, challenges in high integration, and significant energy losses due to a leakage current.

Therefore, it is necessary to develop a next-generation neuron circuit that consumes as little power as possible.
Related Art: Korean Patent No. 10-2107784 (Apr. 28, 2020)

### SUMMARY

The present disclosure provides a nano electromechanical neuron device based on a spiking neural network, the device capable of achieving area gains by replacing a large number of transistors to implement a conventional CMOS-based neuron with a single nano electromechanical relay switch.

The present disclosure also provides a nano electromechanical neuron device based on a spiking neural network, the device in which a nano electromechanical relay switch is integrated three-dimensionally on a metal interconnection layer on the CMOS logic circuit, enabling an ultra-high-integrated structure where neuron circuits are implemented on a synapse array.

The present disclosure also provides a nano electromechanical neuron device based on a spiking neural network, the device capable of eliminating dynamic power consumption occurring in transistors and enabling ultra-low-power operation as there is no leakage current due to a nano electromechanical air gap.

In one aspect, there is provided a nano electromechanical neuron device based on a spiking neural network, the device including: a first gate electrode receiving a first voltage; a second gate electrode disposed in parallel and spaced apart from the first gate electrode and receiving a second voltage; a drain electrode disposed at a predetermined distance from one end of the first gate electrode and receiving a spike current signal; a movable beam disposed between the first and second gate electrodes and bending in a direction toward the drain electrode according to a spike current signal; and an anchor for securing the movable beam to a lower layer.

The nano electromechanical neuron device may further include: a membrane capacitor connected to the drain electrode; and an output resistance connected to the movable beam.

The nano electromechanical neuron device may further include a leakage resistance connected in parallel to the same node as the membrane capacitor.

The nano electromechanical neuron device may perform a leaky integrate and fire (LF) operation as charge charged in the membrane capacitor leaks out due to the leakage resistance when no spike current signal is input.

The nano electromechanical neuron device can be integrated in a three-dimensional form on the metal interconnection layer on top of a CMOS logic circuit.

The nano electromechanical neuron device may have a plurality of operating states, and the plurality of operating states comprises: an initial state in which the movable beam is parallel to the gate electrodes between the first gate electrode and the second gate electrode; an integrated state in which the movable beam is bent in the direction of the drain electrode; and a firing state in which the movable beam is in contact with the drain electrode.

The initial state and the integrated state correspond to states in which the movable beam and the drain electrode are physically separated.

The nano electromechanical neuron device may apply a constant voltage to the first gate electrode and the second gate electrode to adjust a threshold potential at which an output spike occurs.

The nano electromechanical neuron device may perform an excitatory operation where, when a positive voltage is applied to the first gate electrode, an electrostatic force is generated in a direction toward the drain electrode, thereby reducing the threshold potential for spike generation.

The nano electromechanical neuron device may perform an inhibitory operation where, when a positive voltage is applied to the second gate electrode, an electrostatic force is generated in the opposite direction of the drain electrode, thereby increasing the threshold potential.

The movable beam is formed of any one selected from copper, aluminum, molybdenum, cobalt, and a combination thereof.

In another aspect, there is provided a nano electromechanical neuron device based on a spiking neural network, the device including: a nano electro mechanical (NEM) relay switch for applying a spike current signal to a drain electrode to perform a pull-in operation of a movable beam with respect to the drain electrode, wherein the spike current signal accumulates and fires during the pull-in operation of the movable beam; a membrane capacitor connected to the drain electrode, charged in an integrated state of the NEM relay switch, and discharged in a firing state of the NEM relay switch; and an output resistor connected to the movable beam and outputting a spike voltage signal due to discharging of the membrane capacitor.

The movable beam may be disposed between the first gate electrode and the second gate electrode, and while one end of the movable beam is secured by an anchor and the other end is not in contact with the first gate electrode and the second gate electrode, the movable beam may be horizontally movable to contact the drain electrode.

The NEM relay switch may be formed on a metal interconnection layer on top of a CMOS logic circuit.

In the NEM relay switch, a charge is stored in an air gap between the drain electrode and the movable beam due to a spike current signal applied to the drain electrode, creating an electrostatic force between the drain electrode and the movable beam, thereby resulting in a pull-in operation of the movable beam to bend toward the drain electrode.

In the NEM relay switch, when a potential of the drain electrode is higher than a preset threshold potential, the movable beam come into contact with the drain electrode, discharging the stored charge in the air gap between the drain electrode and the movable beam and causing a restoring force to act on the movable beam, thereby returning the movable beam to an initial position thereof from the drain electrode.

The NEM relay switch may apply a specific voltage to the first gate electrode or the second gate electrode to adjust the threshold potential for spike generation, thereby exciting or inhibiting spike generation.

In yet another aspect, there is provided a nano electromechanical neuron device based on a spiking neural network, the device including: a nano electro mechanical (NEM) relay switch for applying a spike current signal to a drain electrode to perform a pull-in operation of a movable beam with respect to the drain electrode, wherein the spike current signal accumulates and fires during the pull-in operation of the movable beam; a membrane capacitor connected to the drain electrode, charged in an integrated state of the NEM relay switch, and discharged in a firing state of the NEM relay switch; a leakage resistor connected in parallel to the membrane capacitor and leaking charge stored in the membrane capacitor; and an output resistor connected to the movable beam and outputting a spike voltage signal due to discharging of the membrane capacitor.

When a spike current signal is not applied to the drain electrode, the NEM relay switch may perform a pull-in operation of the movable beam by leaking charge stored in the membrane capacitor through the leakage resistance.

The movable beam is formed of any one selected from copper, aluminum, molybdenum, cobalt, and a combination thereof.

The disclosed technology may have the following effects. However, purposes or effects are not meant to imply that a particular embodiment should include all or only these effects. Therefore, the scope of the disclosed technology should not be understood as being limited thereto.

Unlike conventional neuron circuits that use a large number of transistors, the nano electromechanical neuron device based on a spiking neural network according to an embodiment of the present disclosure can achieve high integration by utilizing a single NEM relay switch integrated into the metal wiring layer.

In addition, the nano electromechanical neuron device based on a spiking neural network according to an embodiment of the present disclosure operates as an open circuit between the movable beam and the drain electrode before a spike occurs, preventing leakage current that occurs in a conventional transistor-based neuron circuit, thereby enabling the implementation of an ultra-low power neuron circuit.

### BRIEF DESCRIPTION OF THE DRAWINGS

FIG. 1 is a configuration diagram illustrating a nano electromechanical neuron device based on a spiking neural network according to an embodiment of the present disclosure.

FIGS. 2 and 3 are diagrams showing a spiking neural network-based nano electromechanical neuron device according to an embodiment of the present disclosure.

FIGS. 4A to 4C are diagrams showing a perspective view (a) and a plan view (b) of each state of a spiking neural network-based nano electromechanical neuron device according to an embodiment of the present disclosure.

FIG. 5 is a diagram illustrating the operation process of a nano electromechanical neuron device based on a spiking neural network according to an embodiment of the present disclosure, and the corresponding equivalent circuit and timing diagram.

FIG. 6 is a graph showing the results of an HSPICE simulation to verify the operation of the nano electromechanical neuron device of FIG. 2.

FIG. 7 is a graph showing the results of an HSPICE simulation to verify the operation of a nano electromechanical neuron device that implements the leaky IF (Leaky Integrate and Fire) operation of FIG. 3.

FIG. 8 is a diagram showing the results of an ANSYS simulation to verify the operation of a spiking neural network-based nano electromechanical neuron device.

### DETAILED DESCRIPTION

The description of the present disclosure is only an embodiment for structural or functional explanation, the scope of the present disclosure should not be construed as limited by the embodiment described herein. In other words, since the embodiment can be modified in various ways and can have various forms, the scope of the present disclosure should be understood to include equivalents that can realize the technical idea. In addition, the objects or effects presented in the present specification does not mean that a specific embodiment should include all of them or only those effects, so the scope of the present disclosure should not be understood to be limited thereby.

Meanwhile, the meaning of the terms described in the present specification should be understood as follows.

The terms such as “first,” “second,” etc. are used to distinguish one component from another, and the scope of the present disclosure should not be limited by these terms. For example, a first component may be named a second component, and similarly, the second component may also be named the first component.

When a component is referred to as being “connected” to another component, it should be understood that it may be directly connected to the other component, but that other components may also exist between them. On the other hand, when a component is referred to be as being “directly connected” to another component, it should be understood that there are no other components between them. Meanwhile, other expressions that describe the relationship between components, such as “between” and “immediately between” or “adjacent to” and “directly adjacent to”, should be interpreted similarly.

Singular expressions should be understood to include plural expressions unless the context clearly indicates otherwise, and terms such as “include” or “have” are intended to designate that the presence of a feature, number, step, operation, component, part, or combination thereof, and should be understood as not excluding in advance the possibility of the presence or addition of one or more other features, numbers, steps, operations, components, parts, or combinations thereof.

For each step, identification codes (e.g., a, b, c, etc.) are used for convenience of explanation. The identification codes do not describe the order of steps, and the steps may occur in any order other than that specified unless the context clearly indicates a specific order. That is, the steps may occur in the same order as specified, may be performed substantially simultaneously, or may be performed in the opposite order.

All terms used herein, unless otherwise defined, have the same meaning as commonly understood by a person of ordinary skill in the field to which the present disclosure pertains. The terms defined in commonly used dictionaries should be interpreted as consistent with the their meaning in the context of the related art, and are not to be interpreted as having an idealized or unduly formal meaning unless expressly defined in the present specification.

Hereinafter, with reference to the accompanying drawings, preferred embodiments of the present disclosure will be described in more detail. In the description of the present disclosure, the same reference numerals are used for the same components in the drawings, and redundant descriptions of the same components are omitted.

Recently, the field of hardware-based artificial neural network technology has necessitated ultra-low power consumption and high energy efficiency for processing massive amounts of data. A hardware-based SNN capable of low-power operation requires neuron circuits for spike operation.

In the present disclosure, a neuron circuit using the low-power and high-integration characteristics of nano electromechanical relay switches will be proposed.

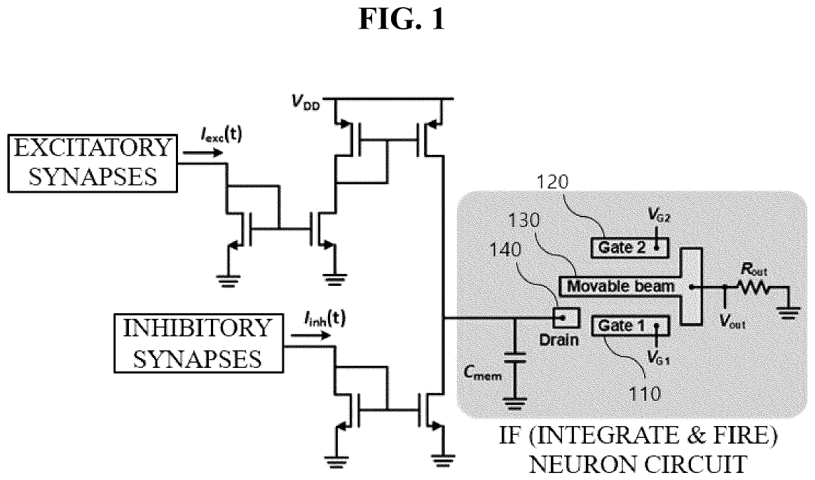

FIG. 1 is a configuration diagram illustrating a nano electromechanical neuron device based on a spiking neural network according to an embodiment of the present disclosure.

Referring to FIG. 1, a spiking neural network device may be composed of synapses and integrate and fire (IF) neuron circuits.

In a spiking neural network (SNN) device, a single neuron processes information from multiple inputs to generate a single spike output signal, which is then transmitted to the next neuron. At this point, the spike is generated when the accumulated signal inputted from a previous stage exceeds a predetermined potential. A neuron's spike generation probability increases with excitatory inputs and decreases with inhibitory inputs. To implement this in hardware, an integrate & fire (IF) circuit that performs the same role as a neuron is required.

Here, the IF neuron circuit may be implemented as a nano electromechanical neuron device using a nano electro mechanical (NEM) relay switch. The NEM relay switch may include two gate electrodes 110 and 120, a movable beam 130 present between the gate electrodes 110 and 120, and a drain electrode 140. The NEM relay switch may apply a spike current signal to the drain electrode 140 to perform a pull-in operation of the movable beam 130 with respect to the drain electrode 140, and perform an IF operation in which accumulation and firing of the spike current signal occurs during the pull-in operation of the movable beam 130. The nano electromechanical neuron device may have an output resistance Rₒᵤₜ connected to the same node as the movable beam 130. The nano electromechanical neuron device may have a membrane capacitor Cₘₑₘ connected to the drain electrode 140. The nano electromechanical neuron device may receive spike signals from synapses, and the spike signals may correspond to currents. The nano electromechanical neuron device may have a plurality of operating states. The plurality of operating states may include an initial state, an integrated state, and a firing state. Each of the plurality of operating states may be determined by the position of the movable beam 130.

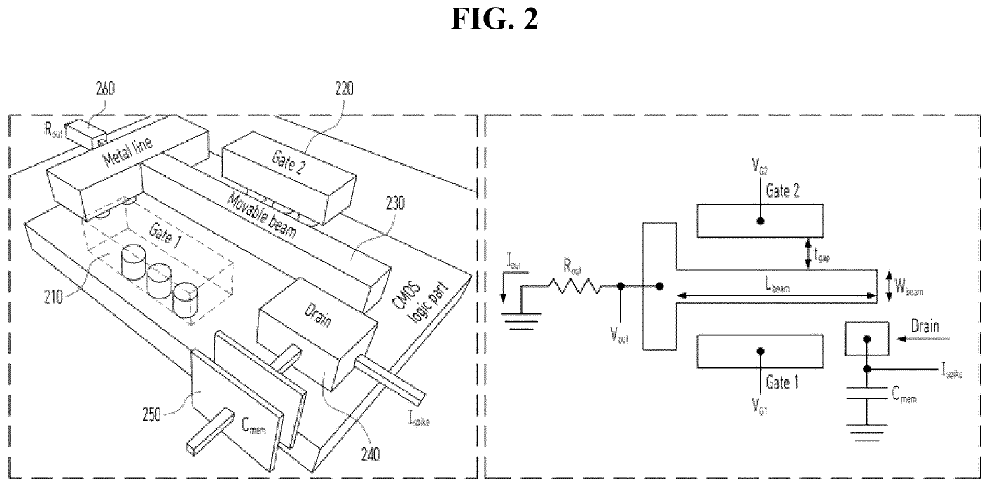

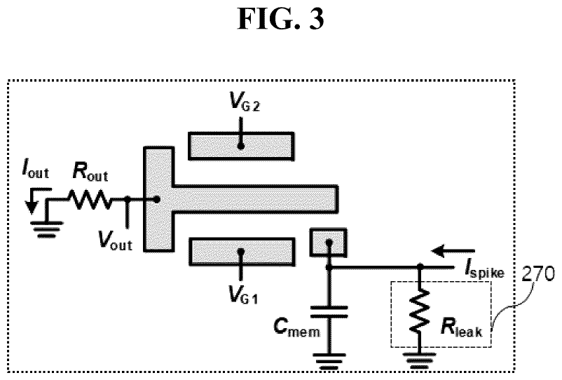

FIGS. 2 and 3 are diagrams showing a spiking neural network-based nano electromechanical neuron device according to an embodiment of the present disclosure. Referring to FIGS. 2 and 3, a nano electromechanical neuron device includes a first gate electrode 210 which receives a first voltage V_{G1}, a second gate electrode 220 which is arranged parallel to and spaced apart from the first gate electrode 210 and receives a second voltage V_{G2}, and a drain electrode 240 which is spaced apart from one end of the first gate electrode 210 and receives a spike current signal Iₛₚᵢₖₑ.

The movable beam 230 is disposed between the first gate electrode 210 and the second gate electrode 220. With one end of the movable beam 230 secured by an anchor and the other end non-contacting the first gate electrode 210 and the second gate electrode 220, the movable beam 230 may be horizontally movable to contact the drain electrode 240. The movable beam 230 bends towards the drain electrode 240 according to a spike current signal Iₛₚᵢₖₑ, and the voltage applied to the drain electrode 240 induces a pull-in operation of the movable beam 230. Here, the movable beam 230 may be formed of one selected from copper Cu, aluminum Al, molybdenum Mo, cobalt Co, and combinations thereof. In one embodiment, if the movable beam 230 has a larger value of Young's modulus, which is a mechanical property that indicates the stiffness of a metallic material, it is harder to pull in. The Young's modulus according to metal type is shown in Table 1 below.

TABLE 1

| Material | Young's modulus (Gpa) |
|---|---|
| Cu | 110 |
| Al | 70 |
| Mo | 330 |
| Co | 220 |

Additionally, an output resistance 260 Rₒᵤₜ is connected to the same node as the movable beam 230, and a membrane capacitor 250 Cₘₑₘ is connected to the drain electrode 240. The membrane capacitor 250 is connected to the drain electrode 240, charged in the integrated state of the NEM relay switch, and discharged in the firing state of the NEM relay switch. The output resistance 260 may be connected to the movable beam 230 and output a spike voltage signal Vₒᵤₜ due to the discharging of the membrane capacitor 250. The device may also include an anchor that secures the movable beam 230 to a lower layer.

Furthermore, as shown in FIG. 3, a leakage resistance 270 Rₗₑₐₖ may be connected in parallel to the same node as the membrane capacitor 250 Cₘₑₘ to implement a leaky integrate and fire (LIF) neuron circuit. In the nano electromechanical neuron device with LIF characteristics, if a spike current signal Iₛₚᵢₖₑ is not input, the charge accumulated in the membrane capacitor 250 Cₘₑₘ leaks through the leakage resistance 270 Rₗₑₐₖ. If the spike current signal is not applied to the drain electrode 240, the NEM relay switch may perform the pull-in operation of the movable beam 230 by leaking the charge accumulated in the membrane capacitor 250 through the leakage resistance 270.

Here, the nano electromechanical neuron device may be integrated in a three-dimensional form in a metal interconnection layer on top of a CMOS logic circuit.

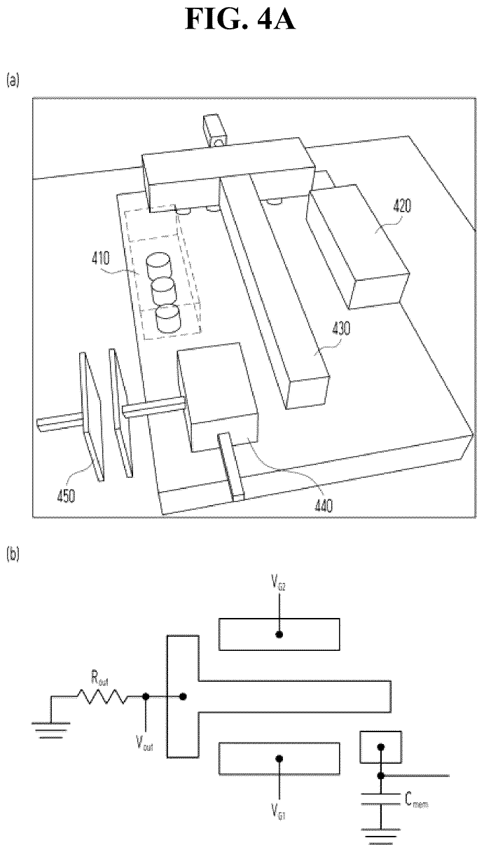

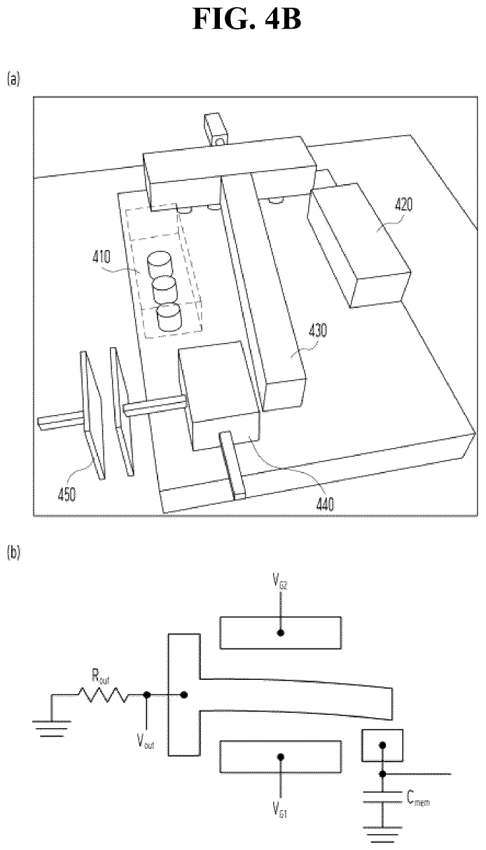

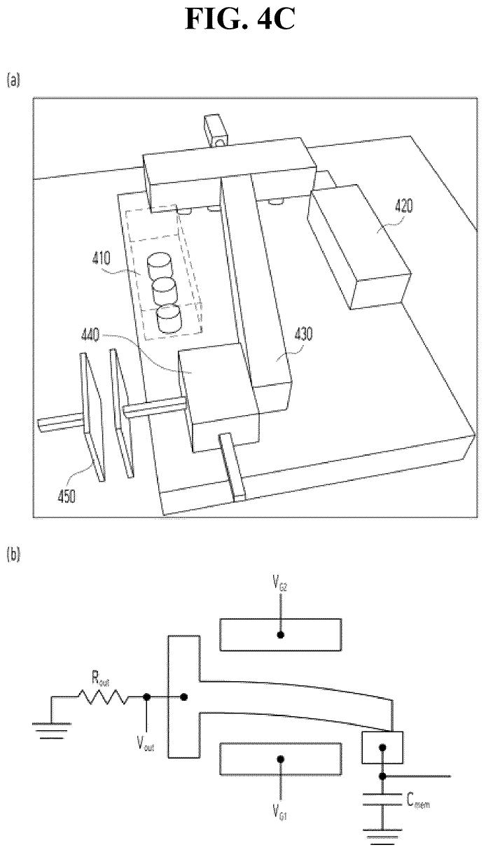

FIGS. 4A to 4C show a perspective view (a) and a top view (b) of each state of a spiking neural network-based nano electromechanical neuron device according to an embodiment of the present disclosure, illustrating the initial, integrated, and firing states of the nano electromechanical neuron device.

First, referring to FIG. 4A, the initial state of the nano electromechanical neuron device refers to a state in which there is no charge stored in a membrane capacitor 450 and no force acts between a drain electrode 440 and a movable beam 430. That is, between the first gate electrode 410 and the second gate electrode 420, the movable beam 430 remains parallel to the gate electrodes 410 and 420.

Referring to FIG. 4B, in the integrated state of the nano electromechanical neuron device, when a current spike signal is input from a previous stage to the drain electrode 440, the drain electrode 440 has a potential as the corresponding charge is stored in the membrane capacitor 450. At this point, an electrostatic force acts between the movable beam 430 and the drain electrode 440, causing the movable beam 430 to gradually bend towards the secured drain electrode 440. Here, the movable beam 430 is bent but not in contact with the drain electrode 440. In the nano electromechanical neuron device, the charge is accumulated in an air gap between the drain electrode 440 and the movable beam 430 due to the spike current signal applied to the drain electrode 440, creating an electrostatic force between the drain electrode 440 and the movable beam 430 and resulting in the pull-in operation of the movable beam 430 to bend toward the drain electrode 440.

Referring to FIG. 4C, in the firing state of the nano electromechanical neuron device, when the potential of the drain electrode 440 exceeds a predetermined threshold, the movable beam 430 comes into contact with the drain electrode 440. If the potential of the drain electrode 440 is higher than a preset threshold potential, the movable beam 430 comes into contact with the drain electrode 440, discharging the charge charged in the air gap between the drain electrode 440 and the movable beam 430 and causing a restoring force to act on the movable beam 430, thereby returning the movable beam 430 to the initial position thereof from the drain electrode 440.

That is, when the movable beam 430 is in a state without stress between the first gate electrode 410 and the second gate electrode 420, this corresponds to the initial state. When the movable beam 430 is bent towards the drain electrode 440 due to an applied force but is not in contact with the drain electrode 440, this corresponds to the integrated state. When the movable beam 430 is in contact with the drain electrode 440 due to a sufficient force, this corresponds to the firing state. This mechanism acts as a switch that utilizes the principle of mechanical movement to configure open and short circuits between the two nodes.

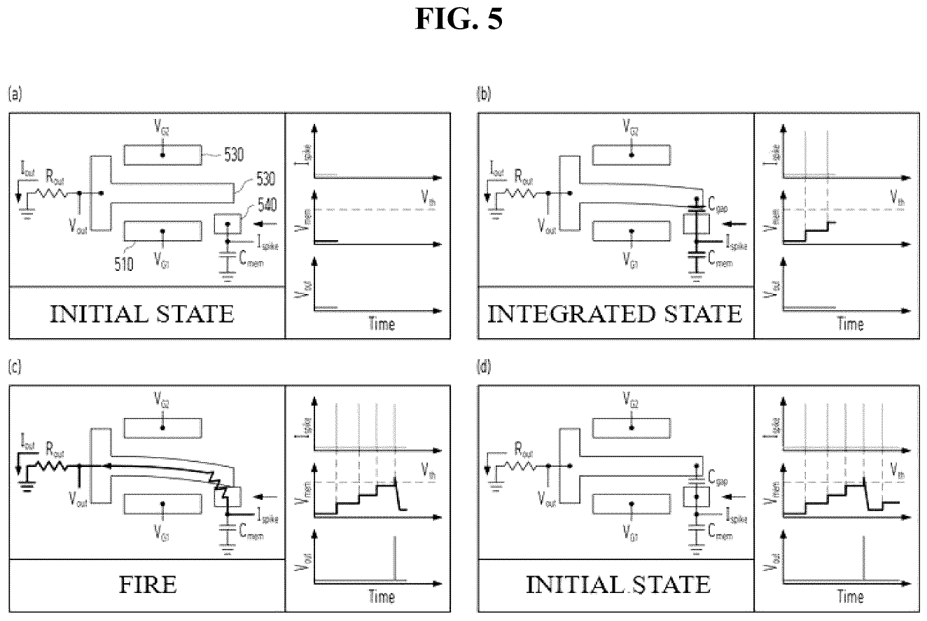

FIG. 5 shows the operation process of a nano electromechanical neuronal device based on a spiking neural network according to one embodiment of the present disclosure, and a corresponding equivalent circuit and timing diagram illustrating a planar circuit diagram of the operation process for the operation states of the nano electromechanical neuronal device.

First, referring to (a) of FIG. 5, which shows an initial state, a movable beam 530 does not contact any of the electrodes, including a first gate electrode 510, a second gate electrode 520, and a drain electrode 540. At this point, when a current spike generated in a previous stage is applied to the drain electrode 540, charge accumulates in capacitors Cgap and Cₘₑₘ formed by the movable beam 530 and the drain electrode 540, applying a positive voltage VD to the drain electrode 540 and gradually pulling the movable beam 530 toward the drain electrode 540 as shown in (b) of FIG. 5. This corresponds to an integration operation, which converts the current spike signal Iₛₚᵢₖₑ generated in the previous stage into potential energy of the movable beam.

Referring to FIG. 5(c), when a voltage higher than a threshold potential is applied to the drain electrode, the movable beam comes into contact with the drain electrode. The air gap present between the drain electrode and the movable beam is converted into a short circuit between the metals, causing a fire operation in which the charge accumulated in the drain electrode is rapidly discharged to the movable beam.

Next, referring to (d) of FIG. 5, the discharged charge causes the generation of a spike current, which, in turn, causes the generation of a spike voltage signal Vₒᵤₜ across the output resistor Rₒᵤₜ connected in series with the movable beam, according to Ohm's law. The charge stored in the drain electrode is rapidly discharged, and the movable beam is subjected only to the restoring force in a direction opposite to the drain electrode, thereby returning to the initial state of the movable beam.

In the operation process of the nano electromechanical neuron device, the threshold potential for spike generation may be adjusted by applying a specific voltage to the first gate electrode 510 or the second gate electrode 520 to excite or inhibit spike generation. That is, a positive voltage V_{G1} applied to the first gate electrode 510 exerts an electrostatic force on the movable beam 530 in a direction toward the drain electrode 540, assisting the movable beam 530 to contact the drain electrode 540 at a lower drain voltage. This corresponds to an excitatory operation that decreases the threshold potential for spike generation in an SNN. Conversely, a positive voltage V_{G2} applied to the second gate electrode 520 exerts an electrostatic force on the movable beam 530 in a direction opposite to the drain electrode 540, causing a fire operation to occur at a higher drain voltage. This corresponds to an inhibitory operation that increases the threshold potential for spike generation.

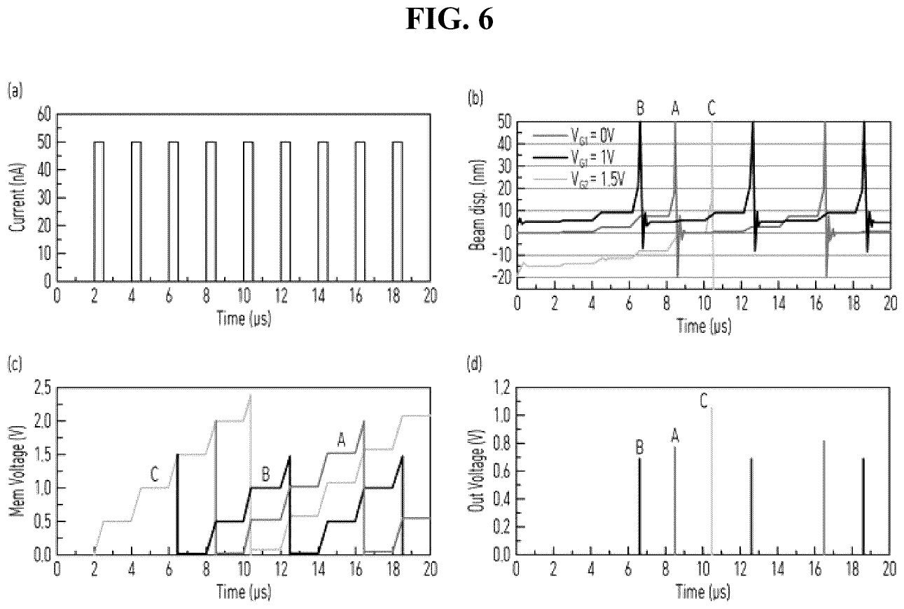

FIG. 6 is a graph showing operation verification through HSPICE simulation of a nano electromechanical neuron device based on a spiking neural network according to an embodiment of the present disclosure.

In FIG. 6, (a) shows a spike current signal input to a drain electrode of the nano electromechanical neuron device based on the spiking neural network. In FIG. 6, (b) shows the position of the movable beam, (c) shows the voltage of the drain electrode, and (d) shows the output spike voltage signal over time.

In FIG. 6, (b) to (d) show a case (A) where there is no gate voltage, a case (B) where a voltage is applied to the first gate electrode (B), and a case (C) where a voltage is applied to the second gate electrode, respectively.

As shown in FIG. 6, it can be confirmed that a spike current accumulates in the drain electrode, and when the accumulated spike current exceeds a predetermined threshold potential, a pull-in operation of the movable beam occurs, generating an output spike voltage. In addition, it can be confirmed that the threshold potential for generating an output spike can be adjusted by applying voltages to the first gate electrode and the second gate electrode.

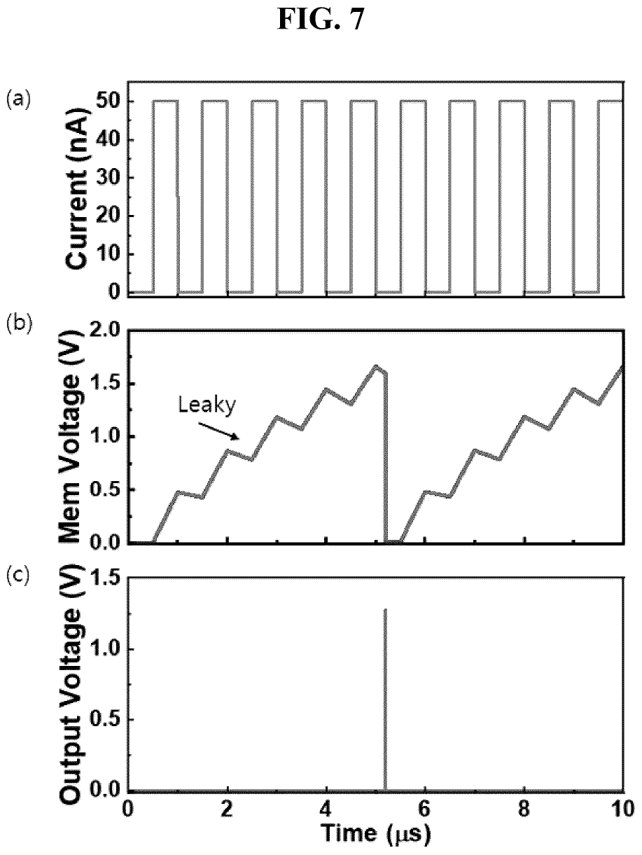

FIG. 7 shows graphs of HSPICE simulation results for a spiking neural network-based nano electromechanical neuron device implementing the leaky IF (Leaky Integrate and Fire) operation of FIG. 3.

In FIG. 7, (a), (b), and (c) show the spike current signal (signal Iₛₚᵢₖₑ), the membrane capacitor voltage (node voltage Cₘₑₘ), and the output resistor voltage (voltage Rₒᵤₜ), respectively. As seen in FIG. 7, the HSPICE simulation results show that charge stored in the membrane capacitor leaks through a leakage resistor Rₗₑₐₖ when no spike current signal is input.

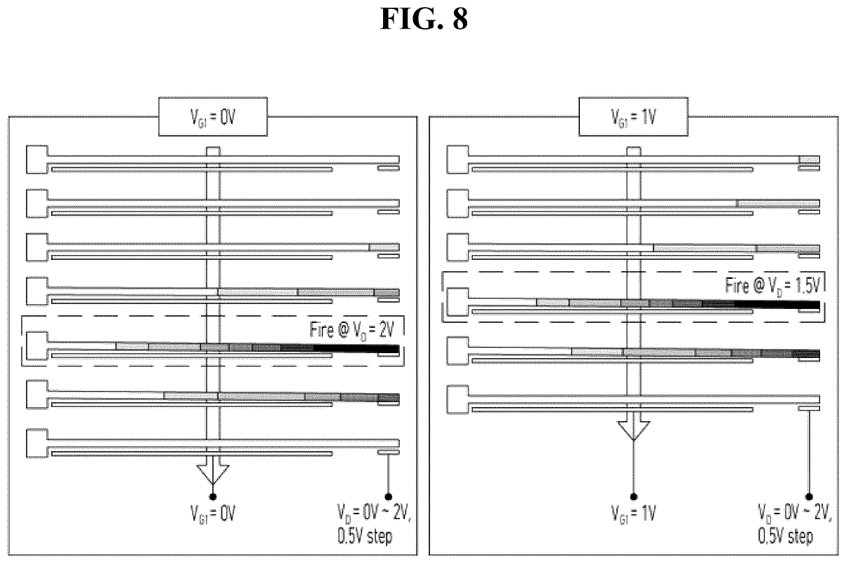

FIG. 8 is a diagram showing an ANSYS simulation for verifying the operation of a nano electromechanical neuron device based on a spiking neural network.

FIG. 8 verifies the operation of the nano electromechanical neuron device through an ANSYS simulation using finite element analysis, illustrating that an integration operation occurs due to a voltage applied to a drain electrode and a fire operation occurs at a drain voltage of approximately 2V. In the case of excitatory, where a voltage is applied to the first gate electrode, the fire operation occurs at a lower drain voltage of 1.5V.

As described above, when implementing a neuron circuit using the major electrostatic force and restoring force in a relay switch operation in a nano electromechanical neuron device based on a spiking neural network, the neuron circuit may achieve high integration by using a single nano electromechanical relay switch integrated into a metal wiring layer, unlike conventional neuron circuits which use a large number of transistors.

In addition, since the movable beam and the drain electrode operate as open circuits to each other before a spike occurs, there is a significant advantage that leakage current, which has been a concern in transistor-based neuron circuits, does not occur.

It is expected that the low-power and high-integration characteristics of a nano electromechanical neuron device based on a spiking neural network according to an embodiment of the present disclosure will contribute to Korea's future dominance and leadership in the next-generation low-power and high-energy efficiency edge AI market. Furthermore, the neuron's nano electromechanical relay switch has strong resistance to radiation and cosmic rays compared to silicon-based devices, which makes it possible to have core components and circuit technologies that operate normally even in extreme situations, which existing transistor-based technologies cannot handle, particularly in the application of artificial neural networks in military and space technology.”

This nano electromechanical neuron device based on a spiking neural network is a technology that can accelerate the implementation of new high-energy efficiency hardware artificial neural networks. It is expected to gain a competitive edge in the rapidly growing ultra-low-power neuromorphic computing field and contribute to leading the overall next-generation low-power and high-energy efficiency artificial intelligence semiconductor market.

While the present disclosure has been described above with reference to preferred embodiments, those skilled in the art may make various modifications and changes to the present disclosure without departing from the spirit and scope of the present disclosure as recited in the following patent claims.

### DETAILED DESCRIPTION OF MAIN ELEMENTS

110, 210, 410, 510: first gate electrode
120, 220, 420, 520: second gate electrode
130, 230, 430, 530: movable beam
140, 240, 440, 540: drain electrode
150, 250: membrane capacitor
260: output resistance
270: leakage resistance

What is claimed is:

1. A nano electromechanical neuron device based on a spiking neural network, the device comprising:
a first gate electrode receiving a first voltage;
a second gate electrode disposed in parallel and spaced apart from the first gate electrode and receiving a second voltage;
a drain electrode disposed at a predetermined distance from one end of the first gate electrode and receiving a spike current signal;
a movable beam disposed between the first and second gate electrodes and bending in a direction toward the drain electrode according to a spike current signal; and
an anchor for securing the movable beam to a lower layer.

2. The device of claim 1, further comprising:
a membrane capacitor connected to the drain electrode; and
an output resistance connected to the movable beam.

3. The device of claim 2, further comprising:
a leakage resistance connected in parallel to a same node as the membrane capacitor.

4. The device of claim 3, wherein perform a leaky integrate and fire (LF) operation as charge charged in the membrane capacitor leaks out due to the leakage resistance when no spike current signal is input.

5. The device of claim 1, wherein the nano electromechanical neuron device is integrated in a three-dimensional form on a metal interconnection layer on top of a CMOS logic circuit.

6. The device of claim 1, wherein the nano electromechanical neuron device has a plurality of operating states, and the plurality of operating states comprises:
an initial state in which the movable beam is parallel to the gate electrodes between the first gate electrode and the second gate electrode;
an integrated state in which the movable beam is bent in the direction of the drain electrode; and
a firing state in which the movable beam is in contact with the drain electrode.

7. The device of claim 6, wherein the initial state and the integrated state correspond to states in which the movable beam and the drain electrode are physically separated.

8. The device of claim 1, wherein the nano electromechanical neuron device applies a constant voltage to the first gate electrode and the second gate electrode to adjust a threshold potential at which an output spike occurs.

9. The device of claim 1, wherein the nano electromechanical neuron device performs an excitatory operation where, when a positive voltage is applied to the first gate electrode, an electrostatic force is generated in a direction toward the drain electrode, thereby reducing the threshold potential for spike generation.

10. The device of claim 1, wherein the nano electromechanical neuron device performs an inhibitory operation where, when a positive voltage is applied to the second gate electrode, an electrostatic force is generated in the opposite direction of the drain electrode, thereby increasing the threshold potential.

11. The device of claim 1, wherein the movable beam is formed of any one selected from copper, aluminum, molybdenum, cobalt, and a combination thereof.

12. A nano electromechanical neuron device based on a spiking neural network, the device comprising:
a nano electro mechanical (NEM) relay switch for applying a spike current signal to a drain electrode to perform a pull-in operation of a movable beam with respect to the drain electrode, wherein the spike current signal accumulates and fires during the pull-in operation of the movable beam;
a membrane capacitor connected to the drain electrode, charged in an integrated state of the NEM relay switch, and discharged in a firing state of the NEM relay switch; and
an output resistor connected to the movable beam and outputting a spike voltage signal due to discharging of the membrane capacitor.

13. The device of claim 12, wherein the movable beam is disposed between the first gate electrode and the second gate electrode, and while one end of the movable beam is secured by an anchor and the other end is not in contact with the first gate electrode and the second gate electrode, the movable beam is horizontally movable to contact the drain electrode.

14. The device of claim 12, wherein the NEM relay switch is formed on a metal interconnection layer on top of a CMOS logic circuit.

15. The device of claim 12, wherein in the NEM relay switch, a charge is stored in an air gap between the drain electrode and the movable beam due to a spike current signal applied to the drain electrode, creating an electrostatic force between the drain electrode and the movable beam, thereby resulting in a pull-in operation of the movable beam to bend toward the drain electrode.

16. The device of claim 15, wherein in the NEM relay switch, when a potential of the drain electrode is higher than a preset threshold potential, the movable beam comes into contact with the drain electrode, discharging the stored charge in the air gap between the drain electrode and the movable beam and causing a restoring force to act on the movable beam, thereby returning the movable beam to an initial position thereof from the drain electrode.

17. The device of claim 13, wherein the NEM relay switch applies a specific to the first gate electrode or the second gate electrode to adjust the threshold potential for spike generation, thereby exciting or inhibiting spike generation.

18. A nano electromechanical neuron device based on a spiking neural network, the device comprising:
a nano electro mechanical (NEM) relay switch for applying a spike current signal to a drain electrode to perform a pull-in operation of a movable beam with respect to the drain electrode, wherein the spike current signal accumulates and fires during the pull-in operation of the movable beam;
a membrane capacitor connected to the drain electrode, charged in an integrated state of the NEM relay switch, and discharged in a firing state of the NEM relay switch;
a leakage resistor connected in parallel to the membrane capacitor and leaking charge stored in the membrane capacitor; and
an output resistor connected to the movable beam and outputting a spike voltage signal due to discharging of the membrane capacitor.

19. The device of claim 18, wherein when a spike current signal is not applied to the drain electrode, the NEM relay switch performs a pull-in operation of the movable beam by leaking charge stored in the membrane capacitor through the leakage resistance.

20. The device of claim 18, wherein the movable beam is formed of any one selected from copper, aluminum, molybdenum, cobalt, and a combination thereof.
